(19) United States
(12) Patent Application Publication
(10) Pub. No.: US 2022/0292506 A1
(43) Pub. Date: Sep. 15, 2022

(54) AUTHORIZATION DEVICE

(71) Applicant: NTT DOCOMO, INC., Chiyoda-ku (JP)

(72) Inventors: Hiroyuki HAKODA, Chiyoda-ku (JP); Yoshiki SAWAKAMI, Chiyoda-ku (JP); Hiroshi KAWAKAMI, Chiyoda-ku (JP)

(73) Assignee: NTT DOCOMO, INC., Chiyoda-ku (JP)

(21) Appl. No.: 17/634,945

(22) PCT Filed: Apr. 17, 2020
(86) PCT No.: PCT/JP2020/016812

§ 371 Date: Feb. 11, 2022

(30) Foreign Application Priority Data
Aug. 26, 2019 (JP) 2019-154009

(51) Int. Cl. G06Q 20/40; G06Q 20/06

(52) U.S. Cl. CPC G06Q 20/4014; G06Q 20/405; G06Q 20/4016; G06Q 20/065

(57) ABSTRACT

Provided is an authorization device that enables approval of a user's payment transaction with no need for separate verification by telephone or the like. In an authorization server (100), a traffic based authorization determination unit (102) determines legitimacy of payment by a user terminal (300) in an affiliated store server (200) being a payment server on the basis of traffic information containing access time of the user terminal (300) and server information being an access destination. Then, an authorization control unit (101) performs processing for enabling a payment transaction on the basis of this determination result.

### TECHNICAL FIELD

The present invention relates to an authorization device that approves a payment transaction.

### BACKGROUND ART

Patent Literature 1 contains a description about authorizing a credit card by telephone when doing Internet shopping with the credit card, so that payment verification by telephone is done at a user's convenience while ensuring safety.

### CITATION LIST

### Patent Literature

PTL1: Japanese Unexamined Patent Publication No. 2002-157537

### SUMMARY OF INVENTION

### Technical Problem

However, according to the invention disclosed in the above-described Patent Literature 1, an online merchant needs to make an inquiry, and a user needs to receive a telephone call, which is complex.

To solve the above problem, an object of the present invention is to provide an authorization device that enables approval of a user's payment transaction with no need for separate verification by telephone or the like.

### Solution to Problem

An authorization device according to the present invention includes a determination unit configured to determine legitimacy of payment by a user terminal in a payment server on the basis of traffic information containing access time of the user terminal and an access destination, and a processing unit configured to perform processing for enabling a payment transaction on the basis of a determination result by the determination unit.

This configuration enables approval of a user's payment transaction on the basis of traffic information, without need for separate verification by telephone or the like.

### Advantageous Effects of Invention

The present invention enables approval of a user's payment transaction with no need for separate verification by telephone or the like.

### BRIEF DESCRIPTION OF DRAWINGS

FIG. 1 is a view showing a system configuration of an approval system according to this embodiment;

FIG. 2 is a view showing a system configuration including an authorization server 100 according to a first embodiment;

FIG. 3 is a view showing a specific example of an affiliated store information DB 103;

FIG. 4 is a view showing a specific example of a customer information DB 104;

FIG. 5 is a flowchart showing the operation of an authorization control unit 101 in the authorization server 100;

FIG. 6 is a flowchart showing the operation of a traffic based authorization determination unit 102;

FIG. 7 is a view showing an authorization server 100a according to an alternative example of the first embodiment;

FIG. 8 is a flowchart showing the operation of the authorization server 100a according to the alternative example;

FIG. 9 is a flowchart showing a process of a traffic based authorization determination unit 102a according to the alternative example;

FIG. 10 is a block diagram showing a system configuration of an authorization server 100b according to a second embodiment;

FIG. 11 is a flowchart showing the operation of the authorization server 100b according to the second embodiment;

FIG. 12 is a flowchart showing the operation of a traffic based authorization determination unit 102b;

FIG. 13 is a block diagram showing a functional configuration of an authorization server 100c according to an alternative example;

FIG. 14 is a flowchart showing the operation of the authorization server 100c according to the alternative example; and

FIG. 15 is a view showing an example of a hardware configuration of an authorization server 100 according to one embodiment of the present disclosure.

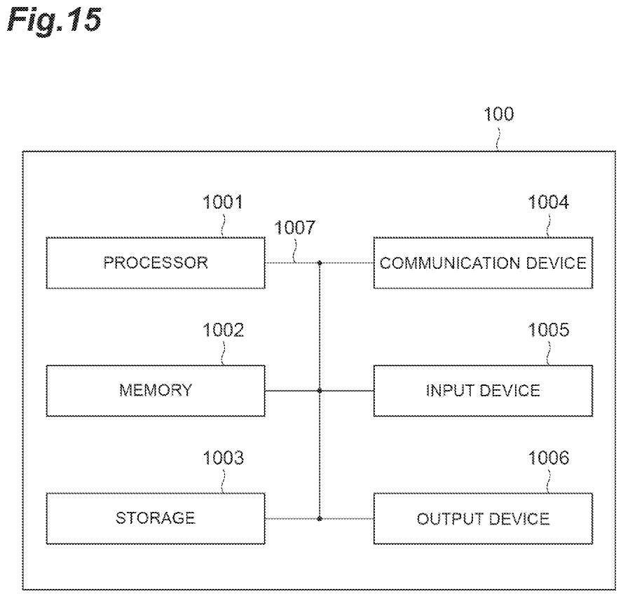

### DESCRIPTION OF EMBODIMENTS

Embodiments of the present invention are described hereinafter with reference to the attached drawings. Note that, where possible, the same elements are denoted by the same reference symbols and redundant description thereof is omitted.

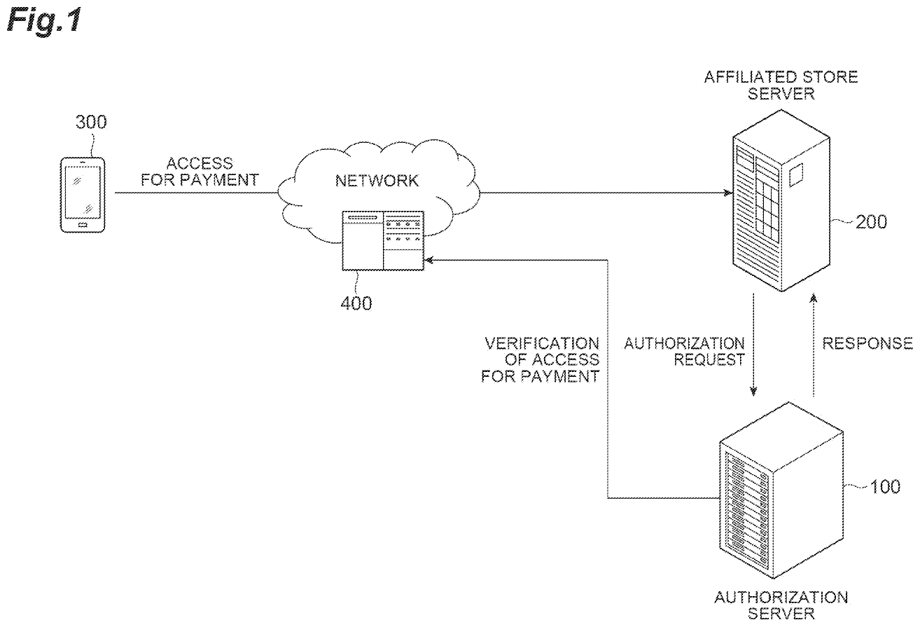

FIG. 1 is a view showing a system configuration of an approval system according to this embodiment. A user terminal 300 accesses an affiliated store server 200 (payment server) and makes a payment transaction. For example, the affiliated store server 200 is a server that provides an Internet shopping site, and a user of the user terminal 300 accesses the affiliated store server 200 and does shopping by using a credit card. This user terminal 300 may be a mobile terminal such as a smartphone that connects to and communicates with a mobile communication network or a communication terminal such as a personal computer that is connected to a fixed line.

The affiliated store server 200 makes a request to approve a payment transaction for credit card payment to an authorization server (an authorization server, which is hereinafter referred to simply as an authorization server) 100. The authorization server 100 determines the legitimacy of the payment on the basis of whether there is an access history to this affiliated store server 200 by using an access log of the user terminal 300 that is stored in an ISP server 400. On the basis of this determination result (the legitimacy of the payment), the affiliated store server 200 makes a payment transaction for the user terminal 300. Note that an access history stored in a proxy server or the like may be used without using the ISP server 400. Alternatively, an access history transmitted from the user terminal 300 may be used.

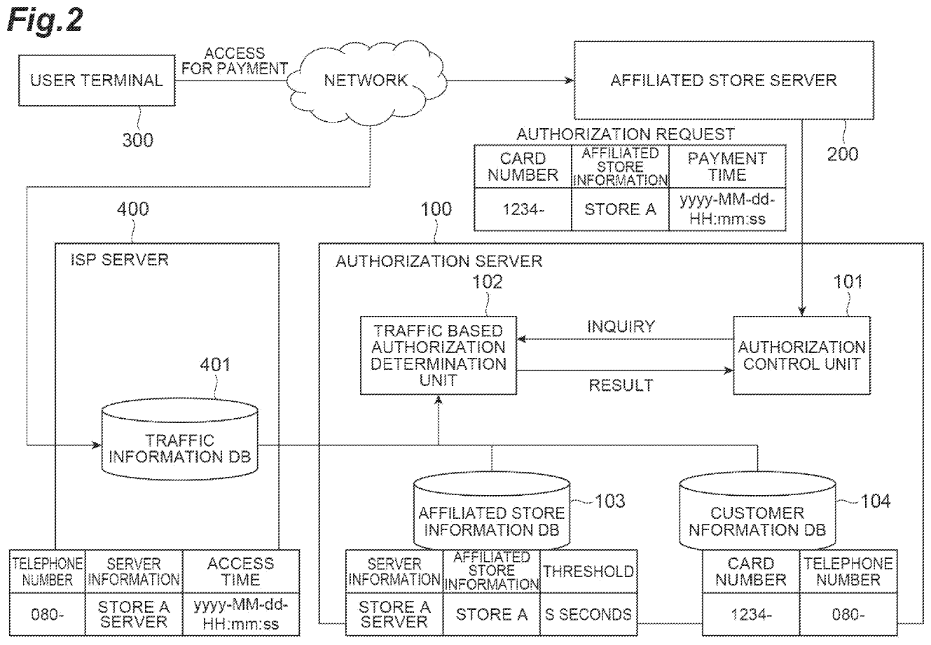

FIG. 2 is a view showing a system configuration including an authorization server 100 according to a first embodiment. As shown in FIG. 2, the authorization server 100 includes an authorization control unit 101 (receiving unit, processing unit), a traffic based authorization determination unit 102 (determination unit), an affiliated store information DB 103, and a customer information DB 104. The authorization server 100 may acquire an access log of the user terminal 300 by using a traffic information DB 401 in an ISP server 400.

The authorization control unit 101 is a part that receives an authorization request, i.e., a request to determine the legitimacy of payment, from the affiliated store server 200, and makes an inquiry to the traffic based authorization determination unit 102. Specifically, the authorization control unit 101 receives an authorization request containing a card number of a credit card, affiliated store information, and payment time, and performs approval processing of the payment with this credit card by using these information in response to the authorization request received from the affiliated store server 200. The authorization control unit 101 transmits a determination result as to whether this payment is legitimate or not to the affiliated store server 200.

The traffic based authorization determination unit 102 determines whether the payment of the credit card is legitimate or not on the basis of the card information, the affiliated store information, and the payment time provided with the inquiry from the authorization control unit 101. Specifically, when the traffic based authorization determination unit 102 receives an inquiry from the authorization control unit 101, it determines the legitimacy of the payment for which the authorization request is made on the basis of the traffic information DB 401 in the ISP server 400, the affiliated store information DB 103, and information in the customer information DB 104. The details are described later.

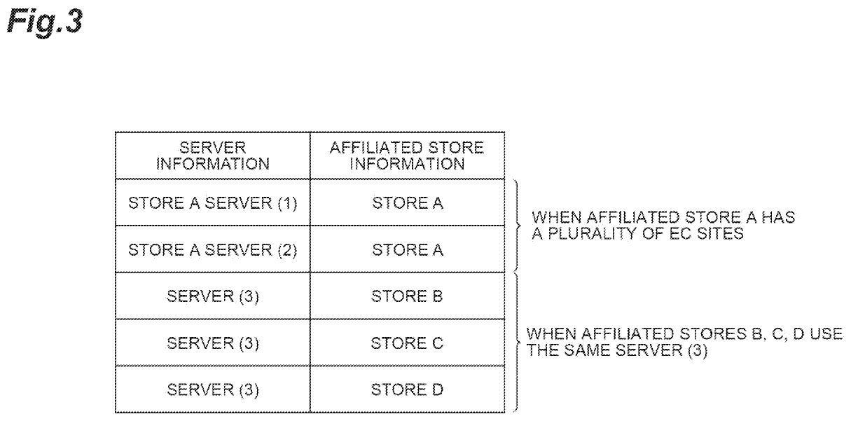

The affiliated store information DB 103 is a part that stores information about affiliated stores. To be specific, the affiliated store information DB 103 stores server information, affiliated store information, and a threshold in association with one another. The affiliated store information is information for identifying a company or store (which is referred to as an affiliated store) that runs an Internet shopping site or the like. One affiliated store can operate a plurality of servers, and one server can be shared among a plurality of affiliated stores. Thus, as shown in FIG. 3, the server information and the affiliated store information may be in one-to-many or many-to-one association. Further, they may be in many-to-many association.

Further, the timing to request an authorization request (payment time) differs depending on the affiliated store. The threshold is information for eliminating a difference from access time according to this timing. When a difference between the payment time and the access time is within the threshold, this payment is determined to be legitimate.

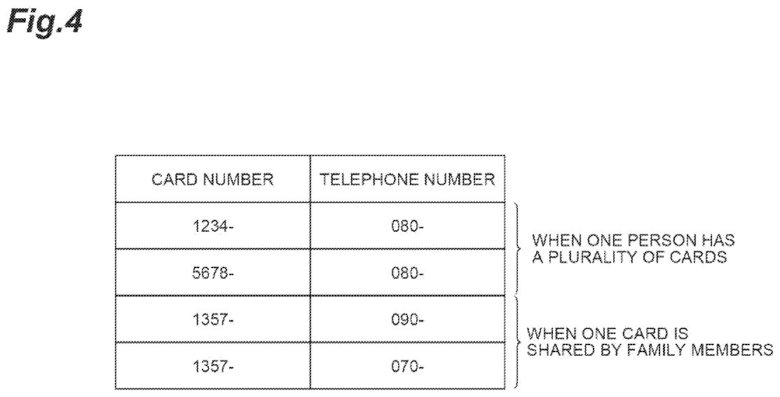

The customer information DB 104 is a part that stores a card number of a credit card and a line identifier (telephone number: user information) of a user who owns this credit card in association with each other. One person can have a plurality of credit cards, and one credit card can be shared among family members. As shown in FIG. 4, the card number and the telephone number may be in one-to-many or many-to-one association in some cases. Further, they may be in many-to-many association.

The traffic information DB 401 in the ISP server 400 is a part that stores a line identifier (e.g., telephone number) of the user terminal 300, server information as an access destination to which this user terminal 300 has accessed, and access time. The ISP server 400 is a server for the user terminal 300 to access a network such as the Internet. The ISP server 400 stores an access log of the user terminal 300.

Although a telephone number is used as an example of the line identifier in the following description, it is not limited thereto. Further, as another technique, the traffic information DB 401 may store an IP address, access time, an access destination and the like in association with one another, and a table in which the IP address and a line identifier are associated may be prepared separately. Then, the access time and the like of the user terminal 300 may be identified by specifying the line identifier by using the IP address as a key.

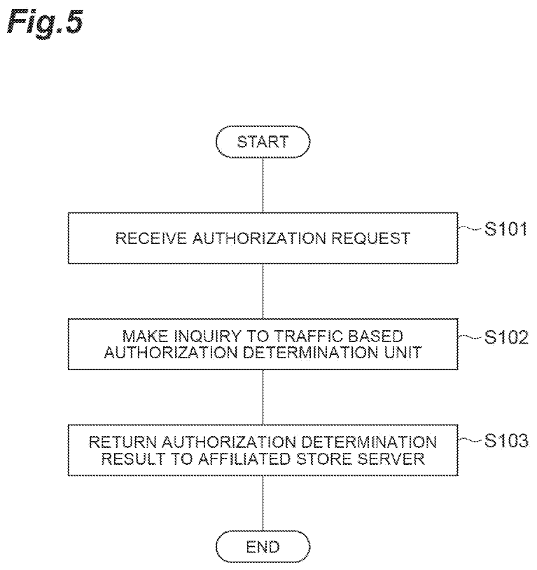

The operation of the authorization server 100 having the above configuration is described hereinafter. FIG. 5 is a flowchart showing the operation of the authorization control unit 101 in the authorization server 100. As shown in FIG. 5, the authorization control unit 101 receives an authorization request from the affiliated store server 200 (S101). This authorization request contains a card number, affiliated store information, and payment time.

The authorization control unit 101 makes an inquiry to the traffic based authorization determination unit 102 by using the authorization request (card number, affiliated store information, and payment time) (S102). The authorization control unit 101 acquires a determination result by the traffic based authorization determination unit 102, and transmits it to the affiliated store server 200 (S103). The determination result is an approval result, and it indicates whether payment by a credit card is legitimate or not.

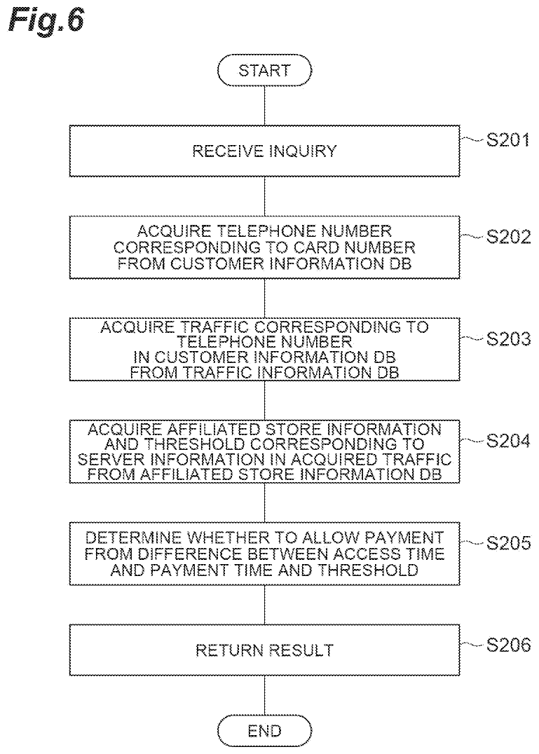

The operation of the traffic based authorization determination unit 102 is described hereinafter with reference to FIG. 6. FIG. 6 is a flowchart showing this operation. This flowchart corresponds to the processing of S102 in FIG. 5.

When the traffic based authorization determination unit 102 receives an inquiry from the authorization control unit 101 (S102, S201), it refers to the customer information DB 104, and acquires the telephone number corresponding to the card number contained in the authorization request (S202).

Next, the traffic based authorization determination unit 102 refers to the traffic information DB 401 by using the acquired telephone number as a key, and thereby acquires the corresponding traffic information (server information and access time) (S203).

Then, the traffic based authorization determination unit 102 refers to the affiliated store information DB 103 by using the server information in the acquired traffic information as a key, and thereby acquires the affiliated store information and the threshold (S204). The traffic based authorization determination unit 102 determines the legitimacy of payment from a difference between the access time in the traffic information and the payment time contained in the authorization request, and the threshold (S205). When the difference is less than the threshold, the traffic based authorization determination unit 102 determines that this payment is legitimate, and when the difference is equal to or more than the threshold, it determines that this payment is not legitimate.

The traffic based authorization determination unit 102 transmits this determination result to the authorization control unit 101 (S206).

In this manner, the authorization server 100 according to the first embodiment is able to determine the legitimacy of payment on the basis of a difference between the access time of the user terminal 300 and the payment time by the user terminal 300.

Note that the processing of S204 and S205 is not limited to the above. For example, the traffic based authorization determination unit 102 may determine the legitimacy of the payment on the basis of the payment time, the last access time, and the threshold when the number of accesses in the traffic information stored in the traffic information DB 401 is equal to or greater than a specified number. Generally, when the user terminal 300 makes a payment on a shopping site or the like, page transition occurs several times in this site, and therefore accesses are stored several times. Thus, when the number of accesses is equal to or less than a predetermined number (for example, only one), it is appropriate in some cases to determine that this payment is not legitimate even if a time difference between the payment time and the access time is small.

Further, as other information, the past payment record may be used. For example, the payment history of the user terminal 300 in each affiliated store (or each affiliated store server) may be stored, and the legitimacy of payment may be determined according to this information. When the number of records in the payment history in each affiliated store is less than a predetermined number, it may be determined that this payment is not legitimate even if a difference between the payment time from the affiliated store server and the access time in the affiliated store server is equal to or less than a predetermined value.

Furthermore, as other information, users may be sorted by age group and gender into segments, and the legitimacy may be determined according to the characteristics of each segment. For example, a user's selection between same-day shipment and normal shipment (shipment after certain days) when doing Internet shopping may depend on segments (age group and gender). In the case of same-day shipment, an authorization request will be sent soon, whereas in the case of normal shipment, an authorization request will be sent several days later. Such shipment patterns may be different depending on segments, and a threshold may be varied for each segment to determine the legitimacy of payment.

When implementing this processing, the customer information DB 104 or another DB may further store segment information (age group, gender, etc.) of users, and the traffic based authorization determination unit 102 may determine the legitimacy of payment according to the threshold based on the segment information. Further, the customer information DB 104 may further store different thresholds of the number of access time for different segments, and vary determination on the number of accesses for each segment.

Specifically, while the traffic based authorization determination unit 102 determines the legitimacy of payment on the basis of the payment time, the last access time, and the threshold when the number of accesses in the traffic information stored in the traffic information DB 401 is equal to or greater than a specified number as a reference value, this reference value may be different for each segment.

Further, when receiving an inquiry from the authorization control unit 101, the traffic based authorization determination unit 102 may receive an inquiry with a specified identifier such as a telephone number. Specifically, the authorization control unit 101 associates a line identifier with a card number, and when it receives an authorization request, the authorization control unit 101 acquires the line identifier by using the card number as a key, and makes an inquiry to the traffic based authorization determination unit 102. This allows the traffic based authorization determination unit 102 to acquire the traffic information by using the line identifier as a key. This processing is applicable also to an alternative example and a second embodiment.

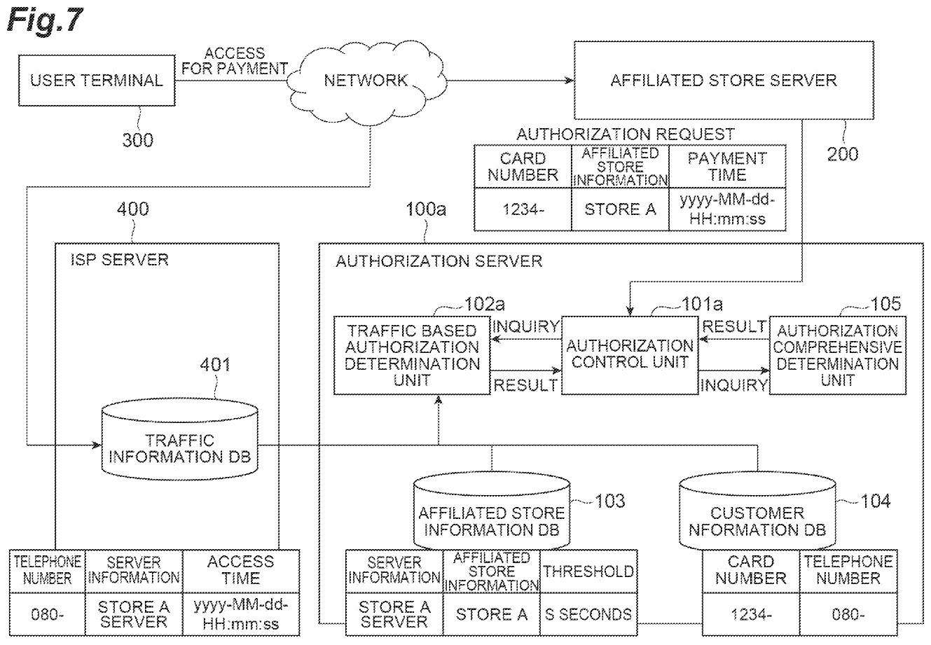

FIG. 7 is a view showing an authorization server 100a according to an alternative example of the first embodiment. The authorization server 100a according to this alternative example performs approval processing by using a probability calculated on the basis of access time of the user terminal 300 and payment time.

The authorization server 100a includes an authorization control unit 101a, a traffic based authorization determination unit 102a, an affiliated store information DB 103, a customer information DB 104, and an authorization comprehensive determination unit 105.

The authorization control unit 101a is a part that receives an authorization request from the affiliated store server 200, and makes an inquiry to the traffic based authorization determination unit 102a. The authorization control unit 101a then makes an inquiry to the authorization comprehensive determination unit 105 on the basis of a determination result by the traffic based authorization determination unit 102a, and transmits a result to the affiliated store server 200.

To be specific, the authorization control unit 101a makes an inquiry to the traffic based authorization determination unit 102a and thereby acquires the probability of legitimacy of a payment transaction by a user. Then, the authorization control unit 101a makes an inquiry to the authorization comprehensive determination unit 105 by using the acquired probability, and thereby acquires a determination result regarding the legitimacy based on this probability.

For example, when the probability is 0.8 or higher, the authorization comprehensive determination unit 105 may determine that the payment by a user in the affiliated store server 200 is legitimate. The probability and a legitimacy determination result are determined according to each affiliated store, and even if the probability is the same, a legitimacy determination result can be different for each affiliated store. This is because the timing of making an authorization request from the affiliated store server 200 is different in each affiliated store. For example, while the affiliated store server 200 in one affiliated store transmits an authorization request immediately after a payment transaction by a user, the affiliated store server 200 in another affiliated store transmits an authorization request next day in some cases.

The traffic based authorization determination unit 102a calculates the probability of whether the payment of the credit card is legitimate or not on the basis of the card information, the affiliated store information, and the payment time provided with the inquiry from the authorization control unit 101a. Specifically, when the traffic based authorization determination unit 102a receives an inquiry from the authorization control unit 101a, it calculates the probability of the legitimacy of the payment for which the authorization request is made on the basis of the traffic information DB 401 in the ISP server 400, the affiliated store information DB 103, and information in the customer information DB 104. This probability calculation is carried out using a function that gives the probability according to the elapsed time from access time to payment time. For example, it is a statistical model, a machine learning model, or another function that is built in such a way that the probability is low for a while after the access time, then rapidly increases with time and reaches its maximum value after a lapse of a specified period of time, and then gradually decreases with time. A model or function that gives a gamma distribution is used, for example. The function is not limited to the above example, and it may be any function as long as the probability decreases with time after a lapse of a specified period of time. This function or model may vary so that the probability is different for each affiliated store or each segment. Further, when calculating the probability, the traffic based authorization determination unit 102a may reflect the threshold corresponding to the affiliated store that is stored in the affiliated store information DB 103. For example, the probability may be calculated using a result of payment time—access time—threshold.

The authorization comprehensive determination unit 105 is a part that receives an inquiry using the probability from the authorization control unit 101a and determines the legitimacy of payment in a comprehensive manner according to this probability. As described earlier, a threshold for determining the probability is set for each affiliated store, and the legitimacy of payment is determined according to the probability provided with the inquiry and the affiliated store.

The affiliated store information DB 103 and the customer information DB 104 are the same as those shown in FIG. 2, and the description thereof is omitted.

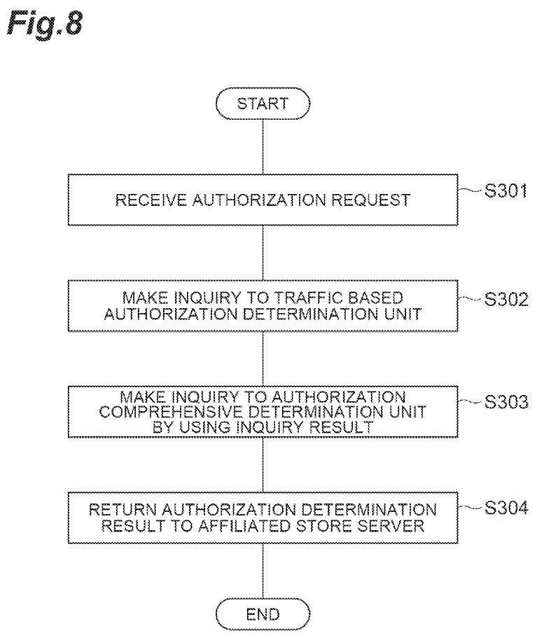

FIG. 8 is a flowchart showing the operation of the authorization server 100a according to the alternative example. The authorization control unit 101a receives an authorization request from the affiliated store server 200 (S301), and makes an inquiry to the traffic based authorization determination unit 102a (S302). Next, the authorization control unit 101a makes an inquiry to the authorization comprehensive determination unit 105 by using a determination result by the traffic based authorization determination unit 102a (S303). The authorization control unit 101a transmits a determination result in the authorization comprehensive determination unit 105 to the affiliated store server 200 (S304).

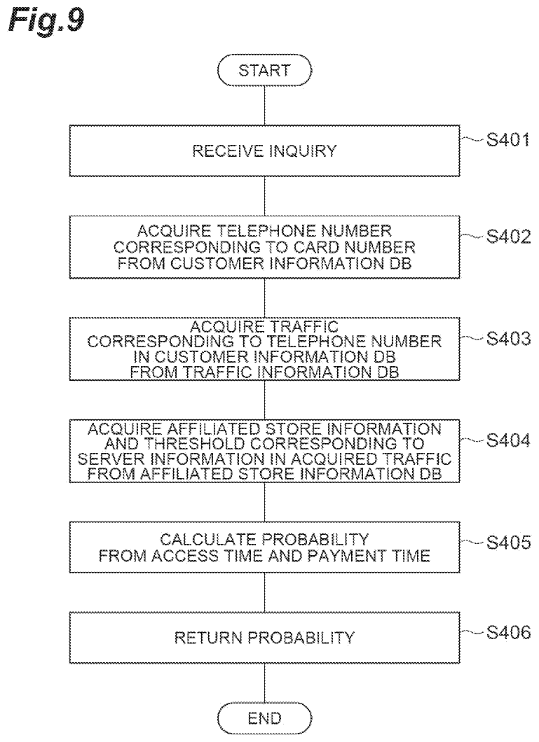

FIG. 9 is a flowchart showing a process of the traffic based authorization determination unit 102a according to the alternative example.

When the traffic based authorization determination unit 102a receives an inquiry from the authorization control unit 101a (S302, S401), it refers to the customer information DB 104, and acquires the telephone number corresponding to the card number contained in the authorization request (S402).

Next, the traffic based authorization determination unit 102a refers to the traffic information DB 401 by using the acquired telephone number as a key, and thereby acquires the corresponding traffic information (server information and access time) (S403).

Then, the traffic based authorization determination unit 102a refers to the affiliated store information DB 103 by using the server information in the acquired traffic information as a key, and thereby acquires the affiliated store information and the threshold (S404). This affiliated store information is used to match with the authorization request. Further, this threshold is used to determine the legitimacy for the probability. While the unit of the threshold is time when a time difference is used for the determination as described earlier, the threshold indicating the criterion for the probability is set to a value between 0 and 1. The traffic based authorization determination unit 102 applies a difference between the access time of the traffic information and the payment time contained in the authorization request to the above-described function for the legitimacy determination, and thereby calculates the probability of the legitimacy of payment (S405).

The traffic based authorization determination unit 102a transmits the probability to the authorization control unit 101 (S406).

The authorization control unit 101a makes an inquiry to the authorization comprehensive determination unit 105 by using the acquired probability, and thereby acquires a determination result of the legitimacy of payment by the user. The authorization comprehensive determination unit 105 makes a comprehensive determination as to whether this payment is legitimate or not by using the probability provided with the inquiry. For example, when the probability provided with the inquiry is equal to or greater than a predetermined value, the authorization comprehensive determination unit 105 determines that this payment is legitimate. When, on the other hand, the probability is less than a predetermined value, the authorization comprehensive determination unit 105 determines that this payment is not legitimate. The authorization control unit 101a transmits the acquired determination result to the affiliated store server 200 (S303 and S304).

Note that the authorization comprehensive determination unit 105 may set a threshold for each affiliated store or each affiliated store server, and make a comprehensive determination on the basis of the threshold corresponding to the affiliated store and the probability for which the inquiry is made.

In this manner, the authorization server 100a according to the alternative example is able to calculate the probability of the legitimacy of payment on the basis of a difference between the time of the authorization request and the payment time, and thereby determine the legitimacy of the payment corresponding to this probability.

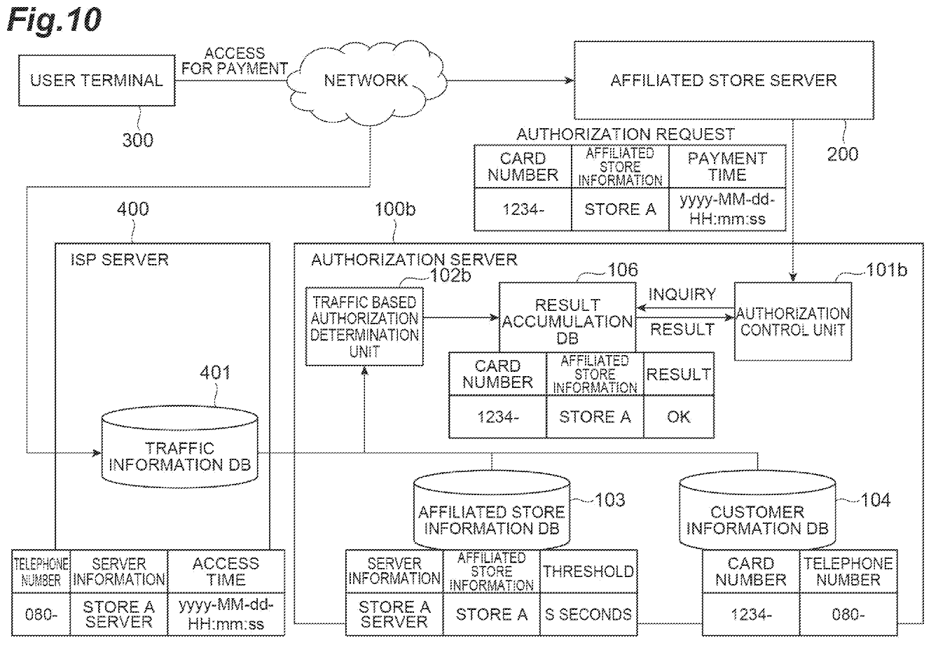

The authorization server 100b according to the second embodiment is described hereinafter. FIG. 10 is a block diagram showing a system configuration of the authorization server 100b according to the second embodiment. As shown in FIG. 10, the authorization server 100b includes an authorization control unit 101b (processing unit, receiving unit), a traffic based authorization determination unit 102b (determination unit), an affiliated store information DB 103, a customer information DB 104 (customer information storage unit), and a result accumulation DB 106 (payment result storage unit).

The authorization control unit 101a is a part that receives an authorization request from the affiliated store server 200, and makes an inquiry to the result accumulation DB 106. The result accumulation DB 106 stores a card number, affiliated store information, and a result indicating whether or not to allow payment in association with one another, and the authorization control unit 101b acquires a result of whether to allow payment by using the authorization request containing the card number and the affiliated store information.

When the traffic information of the user terminal 300 is updated in the ISP server 400, or at specified timing, the traffic based authorization determination unit 102b determines whether the payment with this credit card is legitimate or not on the basis of the card information and the affiliated store information. For example, when the user terminal 300 performs communication, this traffic information is updated in the traffic information DB 401. In response to this update, the traffic based authorization determination unit 102 determines the legitimacy of the payment for which the authorization request is made on the basis of the traffic information DB 401 in the ISP server 400, the affiliated store information DB 103, and information in the customer information DB 104. The traffic based authorization determination unit 102b stores the determination result into the result accumulation DB 106. The details are described later.

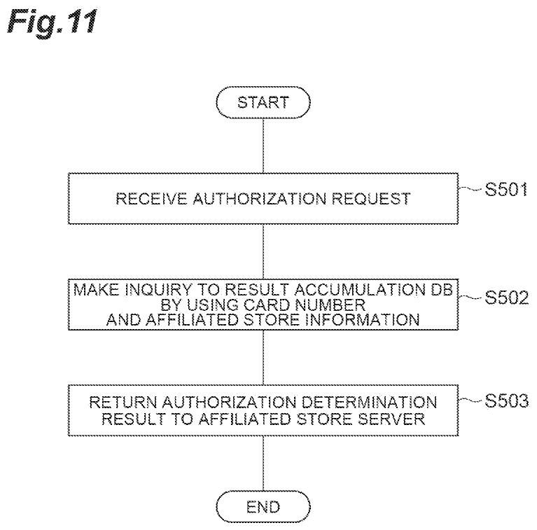

The operation of an authorization server 100b according to a second embodiment is described hereinafter. FIG. 11 is a flowchart showing the operation of the authorization server 100b according to the second embodiment. As shown in FIG. 11, the authorization control unit 101b receives an authorization request from the affiliated store server 200 (S501). This authorization request contains the card number and the affiliated store information.

The authorization control unit 101b makes an inquiry to the result accumulation DB 106 by using the authorization request (the card number and the affiliated store information) (S502). The authorization control unit 101b acquires a determination result and transmits it to the affiliated store server 200 (S503). The affiliated store server 200 makes a payment transaction on the basis of the determination result.

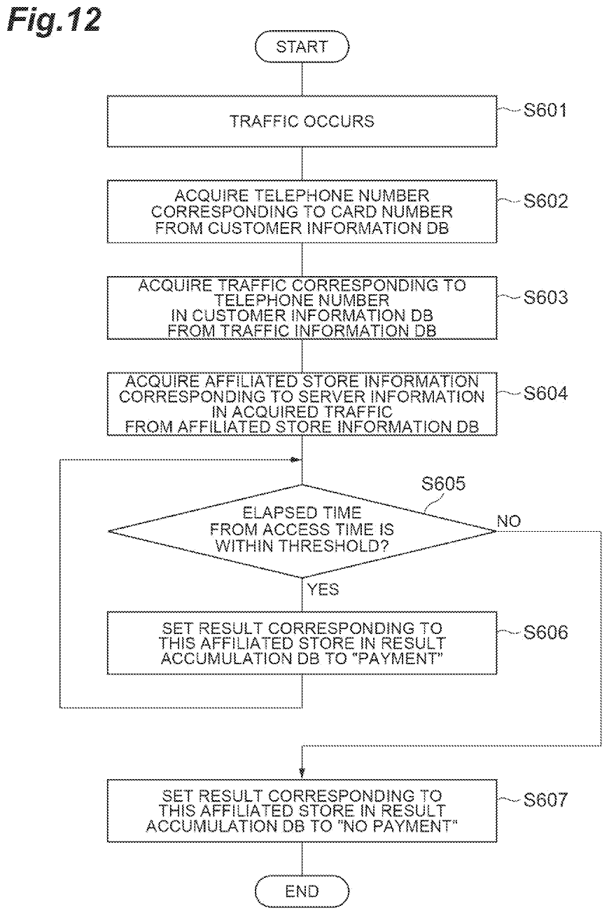

Construction of the result accumulation DB 106 is described next. The result accumulation DB 106 is constructed by the traffic based authorization determination unit 102b. Processing by the traffic based authorization determination unit 102b is described hereinafter. FIG. 12 is a flowchart showing the operation of the traffic based authorization determination unit 102b.

When the traffic based authorization determination unit 102b receives a notification of the occurrence of traffic from the ISP server 400 (S601), the traffic based authorization determination unit 102 refers to the customer information DB 104, and acquires the telephone number corresponding to the card number contained in the authorization request (S602).

Next, the traffic based authorization determination unit 102b refers to the traffic information DB 401 by using the acquired telephone number as a key, and thereby acquires the corresponding traffic information (server information and access time) (S603).

Then, the traffic based authorization determination unit 102b refers to the affiliated store information DB 103 by using the server information in the acquired traffic information as a key, and thereby acquires the affiliated store information and the threshold (S604). The traffic based authorization determination unit 102b determines the legitimacy of payment from a difference between the access time in the traffic information and the current time, and the threshold (S605). When the difference is less than the threshold, the traffic based authorization determination unit 102b determines that this payment is legitimate, and stores “payment” as a result of determination into the result accumulation DB 106 (S606). This is repeated as long as the elapsed time is within the threshold. When the elapsed time from the access time exceeds the threshold, the traffic based authorization determination unit 102b stores “no payment” as a result corresponding to the affiliated store information in the result accumulation DB 106 (S607).

Although a result is updated for each set of the card number and the affiliated store information of the result accumulation DB 106 in the process of FIG. 12, it is not limited thereto.

For example, a record is added to the result accumulation DB 106 for each registration of a determination result. Then, when an authorization control unit 101c receives an authorization request, it may inquire about a determination result corresponding to registration time close to the payment time contained in the authorization request (i.e., registration time within a specified time period) and use it as an authorization result.

This enables accurate determination of payment even when the time from an instruction of payment to a request for authorization is long.

As described above, the result accumulation DB 106 stores information for determining the legitimacy of payment on the basis of the elapsed time from the access time of the user terminal 300. When a specified period of time has elapsed from the access time, the result accumulation DB 106 stores information of “no payment”, and consequently, when the authorization control unit 101b receives an authorization request after a lapse of this specified period of time, this authorization request is determined to be inappropriate.

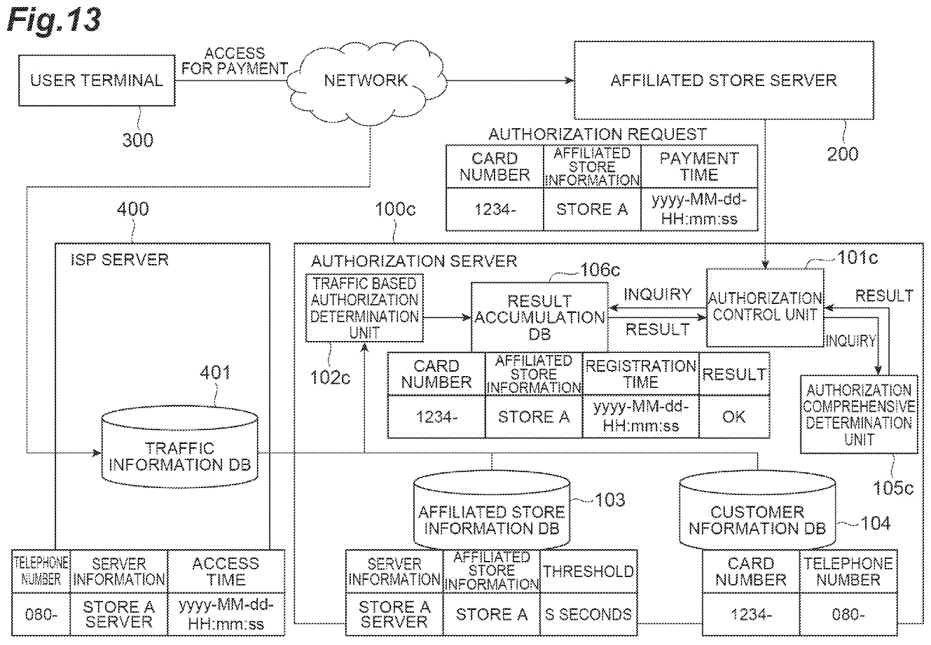

An alternative example of the authorization server 100b according to the second embodiment is described hereinafter. FIG. 13 is a block diagram showing a functional configuration of an authorization server 100c according to the alternative example. This authorization server 100c is different from the authorization server 100b in that it includes an authorization comprehensive determination unit 105c.

Further, the operation of a traffic based authorization determination unit 102c and an authorization control unit 101c are different from those in the authorization server 100b.

When traffic occurs in the user terminal 300, the traffic based authorization determination unit 102c calculates the probability of the legitimacy of payment with the credit card by this user terminal 300 corresponding to the card number and the affiliated store information by referring to the traffic information DB 401, the affiliated store information DB 103, and the customer information DB 104. The calculation of the probability is the same as the processing by the traffic based authorization determination unit 102a.

The traffic based authorization determination unit 102c associates the calculated probability with the card number and the affiliated store information, and stores them together with the calculated time (registration time) into the result accumulation DB 106. The traffic based authorization determination unit 102c calculates the probability that decreases with a lapse of time, and the probability in the result accumulation DB 106 is updated according to the lapse of time. Generally, the probability is updated in such a way that it gradually decreases. Note that the result accumulation DB 106 may update the probability with its registration time so that the same record does not exist, or it may add the probability and its registration time each time as a new record. Although the registration time is not essential, the registration time is used in some cases in the below-described process.

The authorization control unit 101c refers to the result accumulation DB 106c in response to receiving an authorization request, and acquires the probability corresponding to the card number and the affiliated store information.

The authorization control unit 101c makes an inquiry to the authorization comprehensive determination unit 105c by using the acquired probability.

The authorization comprehensive determination unit 105c determines the legitimacy of payment with this credit card by using the probability provided with the inquiry and the affiliated store information. For example, when the probability is equal to or higher than a predetermined value, the authorization comprehensive determination unit 105c determines that the payment with this credit card is legitimate. The authorization comprehensive determination unit 105c returns a determination result, and the authorization control unit 101c sends this result to the affiliated store server 200.

Note that the traffic based authorization determination unit 102c stores registration time when storing the probability into the result accumulation DB 106c, and the authorization comprehensive determination unit 105c may use this registration time to make a determination. For example, the authorization comprehensive determination unit 105c uses the payment time contained in the transmitted authorization request as a key and acquires the probability at the registration time that is close in terms of time from the result accumulation DB 106c, and determines the legitimacy of payment by using the acquired probability.

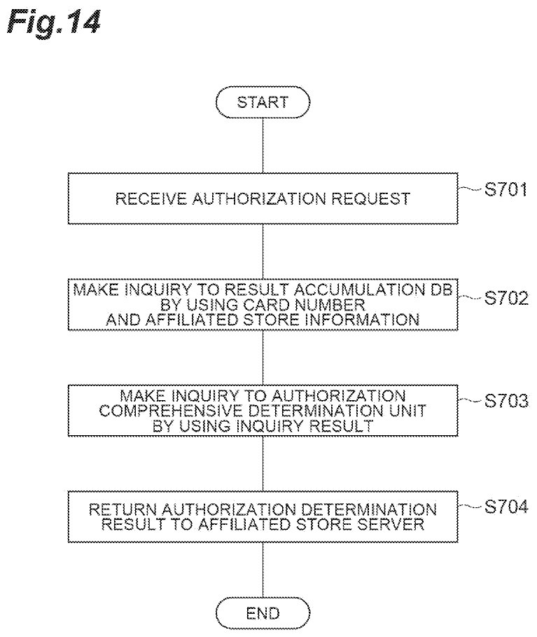

FIG. 14 is a flowchart showing the operation of the authorization server 100c according to the alternative example. It shows a process that focuses on the operation of the authorization control unit 101c.

When the authorization control unit 101c receives an authorization request from the affiliated store server 200, it makes an inquiry to the result accumulation DB 106c by using the authorization request (the card number and the affiliated store information) (S702). The authorization control unit 101c acquires the probability corresponding to the card number and the affiliated store information as a determination result by the traffic based authorization determination unit 102a, and makes an inquiry to the authorization comprehensive determination unit 105c by using this probability (S703). Then, the authorization control unit 101c receives a comprehensive determination result (whether the payment is legitimate or not) from the authorization comprehensive determination unit 105c, and transmits this result to the affiliated store server 200 (S704).

In this manner, the alternative example allows a flexible determination based on the probability.

The operational advantages of the authorization server 100 and the like according to the first embodiment, the second embodiment, and the alternative examples of those embodiments are described hereinafter. In the authorization server 100 according to the first embodiment, the traffic based authorization determination unit 102 determines the legitimacy of payment by the user terminal 300 in the affiliated store server 200 as a payment server on the basis of the traffic information containing the access time of the user terminal 300 and the server information as an access destination. Then, the authorization control unit 101 performs processing for enabling a payment transaction on the basis of this determination result. In this embodiment, the determination result is transmitted to the affiliated store server 200.

This configuration enables approval of a user's payment transaction without separately performing verification by telephone or the like.

Further, in the authorization server 100, the authorization control unit 101 receives an authorization request from the affiliated store server 200. When the authorization control unit 101 receives the authorization request, the traffic based authorization determination unit 102 makes a determination about the possibility of payment, and the authorization control unit 101 notifies the affiliated store server 200 of a determination result as the processing for enabling a payment transaction.

This configuration enables making a determination about the possibility of payment at the timing of the authorization request.

Further, in the authorization server 100, the authorization request contains payment time in the affiliated store server 200, and the traffic based authorization determination unit 102 makes a determination on the basis of the payment time in the affiliated store server 200 and the access time when the access destination of the user terminal 300 is the affiliated store server 200. When the payment time and the access time are close in the case where the affiliated store server 200 and the server indicated by the access destination are the same, the user terminal 300 can determine that a payment transaction is likely to be performed in this server. This enables easy payment verification without using a verification means such as telephone.

Further, in the authorization server 100, the traffic based authorization determination unit 102 makes a determination on the basis of a difference between the payment time in the affiliated store server 200 and the access time in the traffic information, and the threshold determined according to the affiliated store server 200.

The timing of transmitting the authorization request (payment time) can be different for each affiliated store server or each affiliated store that runs this server. Thus, more accurate approval of payment is achieved by setting a threshold for each affiliated store and making a different determination on the legitimacy of payment depending on this threshold, the payment time and the access time.

Further, in the authorization server 100a according to the alternative example, the traffic based authorization determination unit 102a calculates the probability indicating the legitimacy of payment according to a difference between the payment time and the access time. The authorization comprehensive determination unit 105 determines the legitimacy of payment on the basis of this probability.

This configuration calculates the probability of the legitimacy of payment according to a difference between the payment time and the access time, and makes a comprehensive determination about the legitimacy of payment according to this probability. This enables more accurate determination.

The authorization server 100b according to the second embodiment further includes the result accumulation DB 106 that stores a determination result of the legitimacy of payment in the payment server by the user terminal 300, and the traffic based authorization determination unit 102 serving as an update unit that updates information about the legitimacy of payment (a determination result or the possibility (probability) of the legitimacy) in the result accumulation DB 106 on the basis of the traffic information of the user terminal 300. The authorization control unit 101b performs a payment transaction by referring to the result accumulation DB 106.

This configuration stores a determination result of the legitimacy of payment into the result accumulation DB 106 in advance, and promptly performs approval processing upon receiving an authorization request from the affiliated store server 200.

The traffic based authorization determination unit 102b updates the result accumulation DB 106 to indicate that there is no possibility of a payment transaction after a lapse of a specified period of time from the access time, and also updates it in such a way that the possibility of a payment transaction decreases with a lapse of time from the access time.

In any process, approval processing is performed accurately according to the elapsed time.

The authorization server 100 or the like according to this embodiment (the first embodiment, the second embodiment) further includes the customer information DB 104 as a customer information storage unit that stores credit card information for a payment transaction and user information for specifying the user terminal 300.

The authorization control unit 101 refers to the customer information DB 104 and specifies the user information on the basis of the credit card information, and determines the possibility of payment in the payment server on the basis of the specified user information and the traffic information.

The traffic information is stored in the ISP server, and the authorization control unit 101 makes a determination on the basis of the traffic information stored in the ISP server that is acquired by the traffic based authorization determination unit 102.

In general, the traffic information is owned by a telecommunications carrier (ISP server), and the customer information is owned by a credit card company. The legitimacy of payment based on the traffic information is determined by matching those information.

The block diagram used for the description of the above embodiments shows blocks of functions. Those functional blocks (component parts) are implemented by any combination of at least one of hardware and software. Further, a means of implementing each functional block is not particularly limited. Specifically, each functional block may be implemented by one physically or logically combined device or may be implemented by two or more physically or logically separated devices that are directly or indirectly connected (e.g., by using wired or wireless connection etc.). The functional blocks may be implemented by combining software with the above-described one device or the above-described plurality of devices.

The functions include determining, deciding, judging, calculating, computing, processing, deriving, investigating, looking up/searching/inquiring, ascertaining, receiving, transmitting, outputting, accessing, resolving, selecting, choosing, establishing, comparing, assuming, expecting, considering, broadcasting, notifying, communicating, forwarding, configuring, reconfiguring, allocating/mapping, assigning and the like, though not limited thereto. For example, the functional block (component part) that implements the function of transmitting is referred to as a transmitting unit or a transmitter. In any case, a means of implementation is not particularly limited as described above.

For example, the interactive system 100 according to one embodiment of the present disclosure may function as a computer that performs processing of a query sentence generation method in an interactive process according to the present disclosure. FIG. 10 is a view showing an example of the hardware configuration of the interactive system 100 according to one embodiment of the present disclosure. The interactive system 100 described above may be physically configured as a computer device that includes a processor 1001, a memory 1002, a storage 1003, a communication device 1004, an input device 1005, an output device 1006, a bus 1007 and the like.

In the following description, the term “device” may be replaced with a circuit, a device, a unit, or the like. The hardware configuration of the interactive system 100 may be configured to include one or a plurality of the devices shown in the drawings or may be configured without including some of those devices.

The functions of the interactive system 100 may be implemented by loading predetermined software (programs) on hardware such as the processor 1001 and the memory 1002, so that the processor 1001 performs computations to control communications by the communication device 1004 and control at least one of reading and writing of data in the memory 1002 and the storage 1003.

The processor 1001 may, for example, operate an operating system to control the entire computer. The processor 1001 may be configured to include a CPU (Central Processing Unit) including an interface with a peripheral device, a control device, an arithmetic device, a register and the like. For example, the sentence acquisition unit 101, the key acquisition unit 102, the search unit 103, the new candidate acquisition unit 106, the usefulness determination unit 107, the extension processing unit 108, the query sentence generation unit 109 and the like described above may be implemented by the processor 1001.

Further, the processor 1001 loads a program (program code), a software module and data from at least one of the storage 1003 and the communication device 1004 into the memory 1002 and performs various processing according to them. As the program, a program that causes a computer to execute at least some of the operations described in the above embodiments is used. For example, the new candidate acquisition unit 106 in the interactive system 100 and the like may be implemented by a control program that is stored in the memory 1002 and operates on the processor 1001, and the other functional blocks may be implemented in the same way. Although the above-described processing is executed by one processor 1001 in the above description, the processing may be executed simultaneously or sequentially by two or more processors 1001. The processor 1001 may be implemented in one or more chips. Note that the program may be transmitted from a network through a telecommunications line.

The memory 1002 is a computer-readable recording medium, and it may be composed of at least one of ROM (Read Only Memory), EPROM (ErasableProgrammable ROM), EEPROM (Electrically ErasableProgrammable ROM), RAM (Random Access Memory) and the like, for example. The memory 1002 may be also called a register, a cache, a main memory (main storage device) or the like. The memory 1002 can store a program (program code), a software module and the like that can be executed for implementing an interactive processing method according to one embodiment of the present disclosure.

The storage 1003 is a computer-readable recording medium, and it may be composed of at least one of an optical disk such as a CD-ROM (Compact Disk ROM), a hard disk drive, a flexible disk, a magneto-optical disk (e.g., a compact disk, a digital versatile disk, and a Blu-ray (registered trademark) disk), a smart card, a flash memory (e.g., a card, a stick, and a key drive), a floppy (registered trademark) disk, a magnetic strip and the like, for example. The storage 1003 may be called an auxiliary storage device. The above-described storage medium may be a database, a server, or another appropriate medium including the memory 1002 and/or the storage 1003, for example.

The communication device 1004 is hardware (a transmitting and receiving device) for performing communication between computers via at least one of a wired network and a wireless network, and it may also be referred to as a network device, a network controller, a network card, a communication module, or the like. The communication device 1004 may include a high-frequency switch, a duplexer, a filter, a frequency synthesizer or the like in order to implement at least one of FDD (Frequency Division Duplex) and TDD (Time Division Duplex), for example. For example, the above-described sentence acquisition unit 101, presentation unit 104 or the like may be implemented by the communication device 1004. The sentence acquisition unit 101 and the presentation unit 111 may be implemented in a physically or logically separate manner, or may be implemented as one device.

The input device 1005 is an input device (e.g., a keyboard, a mouse, a microphone, a switch, a button, a sensor, etc.) that receives an input from the outside. The output device 1006 is an output device (e.g., a display, a speaker, an LED lamp, etc.) that makes output to the outside. Note that the input device 1005 and the output device 1006 may be integrated (e.g., a touch panel).

In addition, the devices such as the processor 1001 and the memory 1002 are connected by the bus 1007 for communicating information. The bus 1007 may be a single bus or may be composed of different buses between different devices.

Further, the interactive system 100 may include hardware such as a microprocessor, a DSP (Digital Signal Processor), an ASIC (Application Specific Integrated Circuit), a PLD (Programmable Logic Device), and an FPGA (Field Programmable Gate Array), and some or all of the functional blocks may be implemented by the above-described hardware components. For example, the processor 1001 may be implemented with at least one of these hardware components.

Notification of information may be made by another method, not limited to the aspects/embodiments described in the present disclosure. For example, notification of information may be made by physical layer signaling (e.g., DCI (Downlink Control Information), UCI (Uplink Control Information)), upper layer signaling (e.g., RRC (Radio Resource Control) signaling, MAC (Medium Access Control) signaling, annunciation information (MIB (Master Information Block), SIB (System Information Block))), another signal, or a combination of them. Further, RRC signaling may be called an RRC message, and it may be an RRC Connection Setup mess age, an RRC Connection Reconfiguration message or the like, for example.

Further, each of the aspects/embodiments described in the p resent disclosure may be applied to at least one of a system using LTE (Long Term Evolution), LTE-A (LTE Advanced), SUPER 3 G, IMT-Advanced, 4G (4th generation mobile communication system), 5G (5th generation mobile communication system), F RA (Future Radio Access), NR (new Radio), W-CDMA (registered trademark), GSM (registered trademark), CDMA2000, UMB (Ultra Mobile Broadband), IEEE 802.11 (Wi-Fi), IEEE 802.16 (WiMAX), IEEE 802.20, UWB (Ultra Wide Band), Bluetooth (registered trademark), or another appropriate system and a next generation system extended on the basis of these systems. Further, a plurality of systems may be combined (e.g., a combination of at least one of LTE and LTE-A, and 5G) for application.

The procedure, the sequence, the flowchart and the like in each of the aspects/embodiments described in the present disclosure may be in a different order unless inconsistency arises. For example, for the method described in the present disclosure, elements of various steps are described in an exemplified order, and it is not limited to the specific order described above.

The information or the like can be output from an upper layer (or lower layer) to a lower layer (or upper layer). It may be input and output through a plurality of net work nodes.

Input/output information or the like may be stored in a specific location (e.g., memory) or managed in a management table. Further, input/output information or the like can be overwritten or updated, or additional data can be written. Output information or the like may be deleted. Input information or the like may be transmitted to another device.

The determination may be made by a value represented by one bit (0 or 1), by a truth-value (Boolean: true or false), or by numerical comparison (e.g., comparison with a specified value).

Each of the aspects/embodiments described in the present disclosure may be used alone, may be used in combination, or ma y be used by being switched according to the execution. Further, a notification of specified information (e.g., a notification of “being X”) is not limited to be made explicitly, and it may be made implicitly (e.g., a notification of the specified information is not made).

Although the present disclosure is described in detail above, it is apparent to those skilled in the art that the present disclosure is not restricted to the embodiments described in this disclosure. The present disclosure can be implemented as a modified and changed form without deviating from the spirit and scope of the present disclosure defined by the appended claims. Accordingly, the description of the present disclosure is given merely by way of illustration and does not have any restrictive meaning to the present disclosure.

Software may be called any of software, firmware, middle ware, microcode, hardware description language or another name, and it should be interpreted widely so as to mean an instruction, an instruction set, a code, a code segment, a program code, a pro gram, a sub-program, a software module, an application, a software application, a software package, a routine, a sub-routine, an object, an executable file, a thread of execution, a procedure, a function and the like.

Further, software, instructions and the like may be transmitted and received via a transmission medium. For example, when software is transmitted from a website, a server or another remote source using at least one of wired technology (a coaxial cable, an optical fiber cable, a twisted pair and a digital subscriber line (DSL) etc.) and wireless technology (infrared rays, microwave etc.), at least one of those wired technology and wireless technology are included in the definition of the transmission medium.

The information, signals and the like described in the present disclosure may be represented by any of various different technologies. For example, data, an instruction, a command, information, a signal, a bit, a symbol, a chip and the like that can be referred to in the above description may be represented by a voltage, a current, an electromagnetic wave, a magnetic field or a magnetic particle, an optical field or a photon, or an arbitrary combination of them.

Note that the term described in the present disclosure and the term needed to understand the present disclosure may be replaced by a term having the same or similar meaning. For example, at least one of a channel and a symbol may be a signal (signaling). Further, a signal may be a message. Furthermore, a component carrier (CC) may be called a cell, a frequency carrier, or the like.

The terms “system” and “network” used in the present disclosure are used to be compatible with each other.

Further, information, parameters and the like described in the present disclosure may be represented by an absolute value, a relative value to a specified value, or corresponding different information. For example, radio resources may be indicated by an index.

The names used for the above-described parameters are not definitive in any way.

In the present disclosure, the terms such as “Mobile Station (MS)” “user terminal”, “User Equipment (UE)” and “terminal” c an be used to be compatible with each other.

The mobile station can be also called, by those skilled in the art, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a cli ent or several other appropriate terms.

Note that the term “determining” and “determining” used in the present disclosure includes a variety of operations. For example, “determining” and “determining” can include regarding the act of judging, calculating, computing, processing, deriving, investigating, looking up/searching/inquiring (e.g., looking up in a table, a database or another data structure), ascertaining or the like as being “determined” and “determined”. Further, “determining” and “deter mining” can include regarding the act of receiving (e.g., receiving information), transmitting (e.g., transmitting information), inputting, outputting, accessing (e.g., accessing data in a memory) or the like as being “determined” and “determined”. Further, “determining” and “determining” can include regarding the act of resolving, selecting, choosing, establishing, comparing or the like as being “deter mined” and “determined”. In other words, “determining” and “deter mining” can include regarding a certain operation as being “deter mined” and “determined”. Further, “determining (determining)” may be replaced with “assuming”, “expecting”, “considering” and the like.

The term “connected”, “coupled” or every transformation of this term means every direct or indirect connection or coupling between two or more elements, and it includes the case where there are one or more intermediate elements between two elements that are “connected” or “coupled” to each other. The coupling or connection between elements may be physical, logical, or a combination of them. For example, “connect” may be replaced with “access”. When used in the present disclosure, it is considered that two elements are “connected” or “coupled” to each other by using at least one of one or more electric wires, cables, and printed electric connections and, as several non-definitive and non-comprehensive examples, by using electromagnetic energy such as electromagnetic energy having a wavelength of a radio frequency region, a microwave region and an optical (both visible and invisible) region.

The description “on the basis of” used in the present disclosure does not mean “only on the basis of” unless otherwise noted. In other words, the description “on the basis of” means both of “only on the basis of” and “at least on the basis of”.

As long as “include”, “including” and transformation of the m are used in the present disclosure, those terms are intended to be comprehensive like the term “comprising”. Further, the term “or” used in the present disclosure is intended not to be exclusive OR.

In the present disclosure, when articles, such as “a”, “an”, and “the” in English, for example, are added by translation, the present disclosure may include that nouns following such articles are plural.

In the present disclosure, the term “A and B are different” may mean that “A and B are different from each other”. Note that this term may mean that “A and B are different from C”. The terms such as “separated” and “coupled” may be also interpreted in the same manner.

### REFERENCE SIGNS LIST

100, 100a, 100b, 100c . . . authorization server, 300 . . . user terminal, 200 . . . affiliated store server, 400 . . . ISP server, 101, 101a, 101b, 101c . . . authorization control unit, 102, 102a, 102b, 102c . . . traffic based authorization determination unit, 103 . . . affiliated store information DB, 104 . . . customer information DB, 105, 105c . . . authorization comprehensive determination unit, 106, 106c . . . result accumulation DB, 401 . . . traffic information DB

1. An authorization device comprising:
a determination unit configured to determine legitimacy of payment by a user terminal in a payment server on the basis of traffic information containing access time of the user terminal and an access destination; and
a processing unit configured to perform processing for enabling a payment transaction on the basis of a determination result by the determination unit.

2. The authorization device according to claim 1, further comprising:
a receiving unit configured to receive, from the payment server, an authorization request being a request for determination on a payment transaction, wherein
upon receiving the authorization request by the receiving unit, the determination unit makes a determination about possibility of payment, and
the processing unit notifies the payment server of a determination result as the processing for enabling a payment transaction.

3. The authorization device according to claim 2, wherein
the authorization request contains payment time in the payment server, and
the determination unit makes a determination on the basis of the payment time in the payment server and access time of an access destination when there is the same access destination as the payment server.

4. The authorization device according to claim 3, wherein the determination unit makes a determination on the basis of a difference between the payment time and the access time, and a threshold determined according to the payment server.

5. The authorization device according to claim 3, wherein the determination unit calculates probability indicating legitimacy of payment according to a difference between the payment time and the access time, and determines legitimacy of payment on the basis of the probability.

6. The authorization device according to claim 1, further comprising:
a determination result storage unit configured to store a determination result of legitimacy of payment in the payment server by the user terminal; and
an update unit configured to update information about legitimacy of payment in the determination result storage unit on the basis of the traffic information of the user terminal, wherein
the processing unit performs the processing for enabling a payment transaction by referring to the determination result storage unit.

7. The authorization device according to claim 6, wherein the update unit updates information to indicate that there is no possibility of a payment transaction after a lapse of a specified period of time from the access time.

8. The authorization device according to claim 6, wherein the update unit updates information in such a way that possibility of a payment transaction decreases with a lapse of time from the access time.

9. The authorization device according to claim 1, further comprising:
a customer information storage unit configured to store credit card information for a payment transaction and user information for specifying a user terminal, wherein
the determination unit refers to the customer information storage unit and specifies the user information on the basis of the credit card information, and determines possibility of payment in the payment server on the basis of the specified user information and the traffic information.

10. The authorization device according to claim 9, wherein
the traffic information is stored in an ISP server, and
the determination unit makes a determination on the basis of the traffic information stored in the ISP server.

11. The authorization device according to claim 2, further comprising:
a determination result storage unit configured to store a determination result of legitimacy of payment in the payment server by the user terminal; and
an update unit configured to update information about legitimacy of payment in the determination result storage unit on the basis of the traffic information of the user terminal, wherein
the processing unit performs the processing for enabling a payment transaction by referring to the determination result storage unit.

12. The authorization device according to claim 2, further comprising:
a customer information storage unit configured to store credit card information for a payment transaction and user information for specifying a user terminal, wherein
the determination unit refers to the customer information storage unit and specifies the user information on the basis of the credit card information, and determines possibility of payment in the payment server on the basis of the specified user information and the traffic information.

13. The authorization device according to claim 3, further comprising:
a customer information storage unit configured to store credit card information for a payment transaction and user information for specifying a user terminal, wherein
the determination unit refers to the customer information storage unit and specifies the user information on the basis of the credit card information, and determines possibility of payment in the payment server on the basis of the specified user information and the traffic information.

14. The authorization device according to claim 4, further comprising:
a customer information storage unit configured to store credit card information for a payment transaction and user information for specifying a user terminal, wherein
the determination unit refers to the customer information storage unit and specifies the user information on the basis of the credit card information, and determines possibility of payment in the payment server on the basis of the specified user information and the traffic information.

15. The authorization device according to claim 5, further comprising:
a customer information storage unit configured to store credit card information for a payment transaction and user information for specifying a user terminal, wherein
the determination unit refers to the customer information storage unit and specifies the user information on the basis of the credit card information, and determines possibility of payment in the payment server on the basis of the specified user information and the traffic information.

16. The authorization device according to claim 6, further comprising:
a customer information storage unit configured to store credit card information for a payment transaction and user information for specifying a user terminal, wherein
the determination unit refers to the customer information storage unit and specifies the user information on the basis of the credit card information, and determines possibility of payment in the payment server on the basis of the specified user information and the traffic information.

17. The authorization device according to claim 7, further comprising:
a customer information storage unit configured to store credit card information for a payment transaction and user information for specifying a user terminal, wherein
the determination unit refers to the customer information storage unit and specifies the user information on the basis of the credit card information, and determines possibility of payment in the payment server on the basis of the specified user information and the traffic information.

18. The authorization device according to claim 8, further comprising:
a customer information storage unit configured to store credit card information for a payment transaction and user information for specifying a user terminal, wherein
the determination unit refers to the customer information storage unit and specifies the user information on the basis of the credit card information, and determines possibility of payment in the payment server on the basis of the specified user information and the traffic information.
